(19) United States
(12) Patent Application Publication
(10) Pub. No.: US 2008/0071714 A1
(43) Pub. Date: Mar. 20, 2008

(54) METHOD AND APPARATUS FOR CONTROLLING AUTONOMIC COMPUTING SYSTEM PROCESSES USING KNOWLEDGE-BASED REASONING MECHANISMS

(75) Inventors: Barry J. Menich, South Barrington, IL (US); John C. Strassner, North Barrington, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/465,860

(22) Filed: Aug. 21, 2006

(51) Int. Cl. G06N 5/00

(52) U.S. Cl. 706/45

(57) ABSTRACT

A system [100] is provided that includes a Model-Based Translation Layer [200] to accept an input event being formed in any of a pre-determined set of languages and protocols, and output an output message having a common language and protocol. The system [100] also includes a State Processing Layer [300] to (a) parse the output message to determine an event, an externally perceived state of the event, and an internally perceived state of the event; (b) determine a type of the event; (c) determine whether the externally perceived state of the event is substantially equivalent to the internally perceived state of the event; and (d) invoke policy control to lookup action functions to address the event in response to determining that a combination of the type of the event and the externally perceived state of the event is determined to be valid.

### RELATED APPLICATIONS

U.S. application Ser. No. 11/422,681 “AUTONOMIC COMPUTING METHOD AND APPARATUS” as was filed on Jun. 7, 2006 using attorney's docket number CML03322N;

U.S. application Ser. No. 11/422,661 “METHOD AND APPARATUS FOR AUGMENTING DATA AND ACTIONS WITH SEMANTIC INFORMATION TO FACILITATE THE AUTONOMIC OPERATIONS OF COMPONENTS AND SYSTEMS” as was filed on Jun. 7, 2006 using attorney's docket number CML03000N;

U.S. application Ser. No. 11/422,671 “PROBLEM SOLVING MECHANISM SELECTION FACILITATION APPARATUS AND METHOD” as was filed on Jun. 7, 2006 using attorney's docket number CML03124N; and

U.S. application Ser. No. 11/422,642 “METHOD AND APPARATUS FOR harmonizing the gathering of data and issuing of commands in an autonomic computing system using model-based translation” as was filed on Jun. 7, 2006 using attorney's docket number CML02977N;

wherein the contents of each of these related applications are incorporated herein by this reference.

### TECHNICAL FIELD

This invention relates generally to the fields of network and element management, including different means to realize such systems (such as Web Services and grid services), and more particularly to the field of self-managing and self-governing (i.e., autonomic) computing systems.

### BACKGROUND

Networks are often comprised of heterogeneous computing elements, each with their own distinct set of functions and approaches to providing commands and data regarding the operation of those functions. Elements may assume different roles and functions over time and in certain contexts, which in turn requires their configurations to vary. The problem is that even the same product from the same vendor introduces at least two types of problems. The first is that a product can run multiple versions of a device operating system. This illustrates the problem of introducing syntax and semantic changes in a relatively short timeframe (each successive upgrade) over the lifecycle of one or more products. A second example is that a single device can be programmed using different languages (for example, a vendor-proprietary as well as a standard language). This plays havoc with the control loop, as it is now difficult or most likely impossible to deduce which set of monitoring algorithms are used to ensure that a particular set of configuration commands are executed correctly. As a consequence, these computing elements may (and often do) have different, incompatible formats and languages for providing data and receiving commands.

Currently, management elements are built in a custom/stovepipe fashion precisely because of the above limitations. This leads to solution robustness burdened by scalability problems. More importantly, it prohibits management systems from sharing and communicating decisions on similar data and commands. Hence, additional software must be built for each combination of management systems that need to communicate.

Current systems use specific architectures that solve particular problems that constitute a subset of those requiring a solution to enable seamless mobility. Such computing systems do not, however, adequately support means to analyze the semantics involved in operations, administration and management (such as using machine learning or knowledge-based reasoning). Put another way, current computing systems build unique, point solutions for customers from a general-purpose toolset and are not focused on adaptive learning and reasoning frameworks.

Arguably, an important focus of current and future systems is to enable a business to drive the services and resources of a network at any given point in time. Unfortunately, current systems do not provide a general approach that addresses terrestrial and wireless networking. Some autonomic systems have been proposed. However, the proposed systems do not address this problem either. For example, while research can posit the addition of a flexible set of simple machine learning tools that can be brought together to implement rule-reasoning, case-based reasoning, correlation engine functions, and some amount of data mining there are at least two general problems that emerge. First, these solutions do not generalize to causal explanation or inductive expectation. Second, these systems do not interact in any way with information models or ontologies, which have been identified as two mechanisms to provide semantic interoperability and inference.

The ability of these current systems to increase the scope of learning and reasoning capabilities is hampered by being locked into the architectural requirement of custom-built software that provides sensing and command functions. These sensing and command functions are usually of fixed functionality, which exacerbates this problem. Furthermore, this software is embedded in managed elements and must either be changed to accommodate any changes in the learning and/or reasoning capabilities in the autonomic management element(s), or external mediation software must be developed to map the fixed functions embedded in a device into a set of information that manages the application. In addition to this, a further constraint is imposed by conformance to the Common Base Event (“CBE”) standard. While the CBE provides some flexibility in supporting fields for “additional information,” the utility of the approach is compromised by the limited number of event types supported.

While these systems typically include the notions of “self-tuning” or “self-optimization” in their discussions regarding autonomic computing, they have no support for characterizing system operation as a basis for comparison to serve the optimization or tuning processes. Furthermore, there is no concept of a “universal knowledge base,” nor is there a concept of a common set of reasoning mechanisms that can be used to make decisions. Finally, there is no ability to incorporate new knowledge.

Various companies currently vend analysis and decision-making software into the telecommunications and data communications Operation Support Systems (OSS) and Business Support Systems (BSS) markets. Typically, these solutions focus on a particular aspect of analysis and/or decision-making, and always strive to improve the “quality of view” in the system. This last point is crucial in supporting the human-in-the-loop aspect of current system management techniques. Data mining, correlation engines, expert systems, and case-based reasoning all have best-in-class examples of point solution implementations. One example of a current system has combined a case-based reasoning case indexing scheme with utility functions (decision making). In addition, there are many approaches that integrate correlation engines or data mining with rule or case-based systems. None of these solutions, however, provide a general purpose framework, and none of them integrate multiple reasoning and learning techniques.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a conceptual block diagram of an autonomic system based on using the Directory Enabled Network-next generation (“DEN-ng”) model according to at least one embodiment of the invention;

FIG. 2 illustrates a Model Based Translation Layer (“MBTL”) according to at least one embodiment of the invention;

FIG. 3 illustrates the MBLT and a State Processing Layer (“SPL”) according to at least one embodiment of the invention;

FIG. 4 illustrates a first portion of a process flow of the SPL according to at least one embodiment of the invention;

FIG. 5 illustrates a second portion of a process flow of the SPL according to at least one embodiment of the invention;

FIG. 6 illustrates a third portion of a process flow of the SPL according to at least one embodiment of the invention;

FIG. 7 illustrates solicitation response handling for machine learning according to at least one embodiment of the invention;

FIG. 8 illustrates an intelligent reasoning and learning configuration and process flow according to at least one embodiment of the invention;

FIG. 9 illustrates analytic/machine learning and abductive reasoning flow according to at least one embodiment of the invention; and

FIG. 10 illustrates internal knowledge modification according to at least one embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention. Also, although the disclosed embodiments below use DEN-ng, it should be appreciated that other models and ontologies could be used that have similar functionalities.

### DETAILED DESCRIPTION

Complexity takes two fundamentally different forms—system and business complexity. People tend to focus on the former, and concentrate on technology. Business complexity is in some ways more important, however, as it affects the ability of the business to respond to changing demands in an agile fashion.

Complexity arising from system and technology is often spurred on in part by the inexorability of Moore's Law. This is one reason why programmers have been able to exploit increases in technology to build more functional software and more powerful systems. This functionality comes at a price, and the price that has been paid is the increased complexity of system installation, maintenance, (re)configuration and tuning. The trend has been for this complexity to increase. Not only are systems exceedingly complex now, but the components that build them are themselves complex stovepipes, consisting of different programming models and requiring different skill sets to manage them. Traditionally, administrators and users have had to pay this price.

The complexity of doing business is also increasing. End-users typically want simplicity. Ubiquitous computing, for example, motivates the move from a keyboard-based to a task-based model, enabling the user to perform a variety of tasks using multiple input devices in an “always connected” presence. This often requires an increase in intelligence in the system, which is where autonomics comes in.

Autonomics enables governance models to drive business operations and services. In addition, pursuant to the teachings discussed herein, the autonomic system determines that changes (such as environmental conditions, or user needs) have occurred. As a consequence, the autonomic system reconfigures first, its governance model and second, its functionality, to optimize the services and resources that it provides in response to those changes. Autonomic networks and computing systems are mandatory for managing complexity. They enable a better, more efficient, set of capabilities to be built that enables network services and resources to adapt to changing demands.

Generally speaking, pursuant to these various embodiments, a method, apparatus, and system are provided that define a control flow using a common knowledge base and a set of knowledge-based reasoning mechanisms to enable autonomic self-governance. These teachings cause an autonomic computing system to be “self-aware,” incorporating knowledge of its own structure, capabilities, properties and state, its users, and the environment. The system employs this knowledge to adjust its operation when environmental conditions and/or the needs of the user change. In particular, these teachings define various methods to construct an extensible knowledge base that can be used to supply a universal set of definitions, with associated meanings, for a multiplicity of management processes and applications. These teachings also flexibly incorporate one or more machine-based learning and reasoning processes.

This provides numerous advantages over currently used systems. For example, reasoning, machine learning, and other computationally expensive tasks are avoided wherever and whenever possible. The autonomic control loop may always run off of precompiled state-event models unless unmodeled or unexpected events or states are encountered. Failing that, an attempt at resolving problems is often handled first by case-based reasoning. Finally, if case-based reasoning fails, then abductive reasoning and/or analytic learning techniques are employed.

The autonomic system scales through modularity. New learning and reasoning processes can be added without adversely affecting the rest of the architecture. The knowledge base can be extended without adversely affecting the rest of the architecture.

These teachings further scale through software reuse—the addition of new learning and reasoning processes, as well as the extension of the knowledge base, can be done through the use of software patterns. Machine-based learning and reasoning techniques are provided that allow alterations as to how decisions are performed according to current and previous data encountered, as well as current hypotheses that are active.

These teachings enable extensible and enhanced decision-making to be easily added to an autonomic system (this adheres to the basic principle of autonomics, which is to define many simple functions to perform a complex task instead of a single complex function to perform a complex task). It abstracts the specification of the knowledge and reasoning functions, as well as the construction of the knowledge base, from any specific implementation. It therefore can be used with new and/or legacy devices. It can use policy-based management mechanisms to govern which types of learning and reasoning processes should be used (or given priority) in a given context. It can also use policy-based management mechanisms to govern how the knowledge base is extended and customized.

More importantly, these teachings specify the use of semantic processes, which are used to attach additional understanding to data that are received and commands that are sent. This additional understanding enables more complex learning and reasoning algorithms to be used to enable hypotheses and decisions to be formed and analyzed, which the current art cannot do. A common knowledge base and a set of knowledge-based reasoning mechanisms are also defined. Significantly, the addition, removal, and/or alteration of knowledge and algorithms is defined by these teachings. This flexible knowledge base enables the autonomic computing system to be made “self-aware” based on knowledge of itself, its users, and the environment. Self-awareness enables the system to better adjust its operation when environmental conditions and/or the needs of the user change. In particular, various methods to construct an extensible knowledge base are defined that can be used to supply a universal set of definitions, with associated meanings, for a multiplicity of management processes and applications. In addition, a framework is defined in which one or more machine-based learning and reasoning processes can be used. Note that devices and services can be substituted for “user” in the above sentences (and throughout the discussion of various embodiments below). Hence, for simplicity, the disclosed embodiments below refer to “user” in a generic fashion to describe human and non-human entities.

Currently, too much time is being spent on building infrastructure. This is a direct result of people concentrating on technology problems instead of how business is conducted. There is a good reason for this. Concentrating on just the network, different devices have different programming models, even from the same vendor. For example, there are over 250 variations of Cisco IOS 12.0S. This simply represents the Service Provider feature set of IOS, and there are many other different features sets and releases that can be chosen. Worse, the Cisco 6500 Catalyst switch can be run in Internetwork Operating System (“IOS”), CatOS, or hybrid mode, meaning that both the IOS and the CatOS operating systems can be run at the same time in a single device.

A common Service Provider environment is one in which the Command Line Interface (“CLI”) of a device is used to configure it, and Simple Network Management Protocol (“SNMP”) is used to monitor the performance of the device. But a problem arises when mapping between SNMP commands and CLI commands. There is no standard to do this, which implies that there is no easy way to prove that the configuration changes made in CLI solved the problem. Since networks often consist of specialized equipment, each with their own language and programming models, the demand for these teachings is very strong.

The previous problem arose because of the stovepipe, non-uniform way of communicating with devices. This communication is not just for commands, it is also for data. Sensors need to understand the data that they are monitoring, and that can only happen if the data is represented in a common way. Similarly, if two devices use two different languages, then a common language needs to be used to ensure that each device is being told the same thing. Finally, this means that a common set of definitions, facts, and reasoning capabilities must be provided to enable various functionalities, such as allowing different data produced by each device to be analyzed in a common way. The state of different devices may also be related to a set of common goals. Common reasoning mechanisms may be applied to different devices and situations. The reconfiguration of different functionality may be present in each device to support common objectives. Hence, seamless mobility demands knowledge engineering to be used in conjunction with networking in order to achieve its primary goal of letting the business drive the services and resources that are provided.

A typical business imperative is to be able to adjust the services and resources provided by the network in accordance with changing business policies and objectives, user needs, and environmental conditions. In order to do this, the system needs a robust and extensible representation of the current state of the system, and how these three changes affect the state of the system.

The system also needs the ability to abstract and represent the functionality of components in the system into a common form, so that the different capabilities of a given component can be compared. This provides at least three important improvements over the current state of the art. First, components often have very different functionality that is expressed using different terminologies and lexicons (e.g., security and storage functionality). Without a common representation and abstraction, it is impossible for the system to be used efficiently, let alone correctly. Second, different components may affect each other (a routing and a forwarding function may require different queuing implementations on the same interface) and/or common resources (e.g., for a router, its routing and security functions both consume memory and computational resources) of the same device. Without a common representation and abstraction, it is impossible for the device to realize that seemingly different functions either affect or conflict with each other. Third, any constraints (business, technical and other) that are applied to the functionality that the component offers can be properly represented. This enables the system to be, in effect, “reprogrammed” so that it can adjust to faults, degraded operations, and/or impaired operations.

A key design pattern is to build complex functions out of simpler functions. However, different functionality typically cannot be aggregated, much less composed, into higher-level functions unless common semantics can be established between them. Hence, current and future applications require a common knowledge base and reasoning methods to be used.

In order for the above dynamic adjustment to avoid deadlock situations (e.g., of constantly trying to reconfigure elements that in turn cause conflicts with other elements), any all and configuration changes are managed as a closed control loop. This principle may be optimized by the teachings discussed herein by putting any action, such as monitoring interfaces, under a closed control loop. This is done if a common knowledge base and a set of common reasoning methods are present.

The control loop discussed above highlights one of the fundamental tenets of autonomic computing: namely that of controlling modeled and expected behavior. One of the needs for reasoning and machine learning in autonomic systems is to handle those circumstances when behavior is either completely unmodeled, modeled inadequately, or completely unexpected. These situations can occur for a variety of reasons. For example, the system designer typically cannot anticipate all possible states of the modeled element during the design phase of the autonomic system. The designer may also be unable to anticipate all possible events and event types that occur during the lifecycle of the modeled element during the design phase of the autonomic system. Another reason is that the designer could not anticipate all possible failure causes of the modeled element(s) during the design phase of the autonomic system.

In addition, the designer typically could not anticipate all possible element connectivity combinations during the design phase of the autonomic system. This includes not only terrestrial networking components, but wireless access components, applications, and external (e.g., business) processes that affect or necessitate communications (or changes thereof). The designer may also not be able to anticipate qualities and quantities of the dynamics of network interconnections and communications during the design phase of the autonomic system, nor could the designer be typically able to anticipate all possible environmental contexts for system elements during the design phase of the autonomic system. Despite possible “linear” behavior of elements, interacting aggregates of elements could display “nonlinear” behavior that is not predictable a priori.

Moreover, the designer may also not be able to anticipate all possible evolutionary trajectories for the system and its usage during the design phase of the autonomic system. It may not be possible for the designer to anticipate all interaction behaviors of business goals and attempts to satisfy those goals using policy management mechanisms during the design phase of the autonomic system. This is because the designer is unable to anticipate all possible data and information needs from system elements during the design phase of the autonomic system. The designer may also be unable to anticipate all possible combinations of wireless and terrestrial technology handoffs during the design phase of the seamless mobility system, especially when such technologies are combined (e.g., through multiple, alternate networks that can be used at any given time).

The designer may also not be able to anticipate (in advance) all possible optimization objectives, goals, or measurement variables for diverse, heterogeneous systems comprised of different access technologies, different applications, and different infrastructure and access vendors, in a changing environment of business and user needs. Finally, the designer might not anticipate all possible consequences and sequel behaviors due to adaptation or remediation changes in system configuration and parameterization.

Machine learning, as discussed below, describes any technique that uses a history of information from static or dynamic memory structures to enable different types of reasoning functions to be used by themselves or in conjunction with each other. These include abductive reasoning (from effects to causes), deductive reasoning (from the general to the specific), and/or inductive reasoning (from specific instances to general effects). Machine learning also describes techniques used to trim, or prune, possibility spaces.

Knowledge-based reasoning implies the use of precompiled and dynamically assembled knowledge in any of the reasoning activities described below. The use of this assembled knowledge primarily takes the form of associations between elements and also traversing a hierarchy of an object-oriented knowledge structure in the activities of generalization, specialization, composition, and decomposition. In general, it is desirable to use the general-to-specific ordering inherent in object-oriented methods to assist in reasoning activities regarding elements, aggregate of elements, space, time, and hierarchy.

Abductive reasoning implies reasoning about causes from effects. As an example, “diagnosis” is a form of abductive reasoning. One says Q→P (“Q implies P”). In general, the surest forms of abductive reasoning occur when there is an isomorphic mapping between causes and effects. When this is not the case, the underlying probabilities in a homomorphic mapping between causes and effects must be known. In real world examples, this is most always the case. Additionally, there may be intermediate effects between the cause and the ultimate end effect, and so forth. When dealing with probabilities, abductive reasoning is non-deterministic.

Deductive reasoning implies the drawing of logical consequences from a priori knowledge sources. One says P→Q (“P implies Q”), where “P” is the predicate and “Q” is the consequent. Deduction is typically the surest form of reasoning if the predicates are known to be true and the application of logic is consistent and correct.

Inductive reasoning implies reasoning from specific instances to some more general statement. Examples of the use of inductive reasoning are prediction and elements of the scientific method. If it is noted that P(a)→Q(a), P(b)→Q(b), . . . , and so on, one may be tempted to conclude that, for all x, P(x)→Q(x). Thus, a general “rule” is produced which may be retained for later use. Many philosophers in science and technology have noted an “intertwining” between the use of abductive and inductive reasoning in various tasks. This is due to the fact the end product of both is a form of hypothesis.

Two types of precompiled knowledge of interest are “declarative” knowledge and “theories” of operation. The former provides insight into relationships and compositions that may be inserted by autonomic engineers to guide knowledge-based reasoning. There is typically very high confidence in declarative knowledge since it falls into the realm of “fact.” Theoretical knowledge, on the other hand, is knowledge for which one feels less certain, or may have some probability or contingency associated with it.

Both the abductive and inductive reasoning activities have hypotheses as their outputs. In terms of increasing belief confidence, one has utmost confidence in facts, less confidence in theories, and even less confidence in hypotheses. Hypotheses can be “graduated” to the level of theory when certain conditions are met, and this is the purpose of the scientific method. When an inductive or abductive hypothesis can be used to deduce a previously unobserved effect, it is said that the hypothesis has been “strengthened,” and that it may fall more into the category of “theory.” The amount of strengthening required to graduate hypotheses to theory can be use-case specific and is the subject of much debate in the philosophical community.

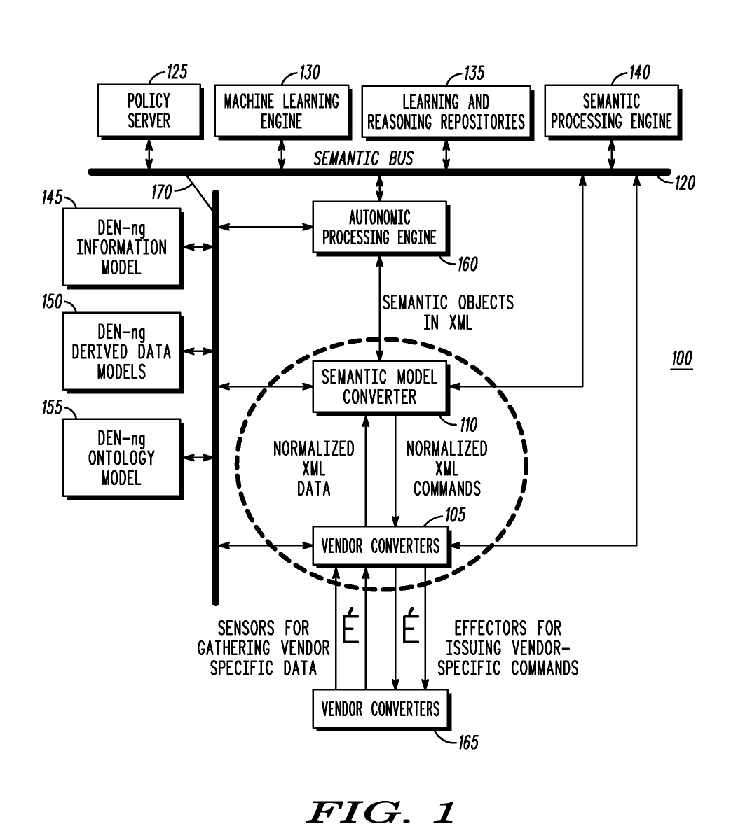

FIG. 1 illustrates a conceptual block diagram of an autonomic system 100 based on using the Directory Enabled Network-next generation (“DEN-ng”) model according to at least one embodiment of the invention. The autonomic system 100 includes a combination of vendor converters 105 and a semantic model converter 110. It also includes a set of interfaces to an information bus 115 and a semantic bus 120, so that it can obtain additional knowledge to perform its tasks. It should be appreciated that models other than DEN-ng may be used that provide the necessary functionality as described herein.

As shown, the autonomic system 100 includes a policy server 125, a machine learning engine 130, learning and reasoning repositories 135, and a semantic processing engine 140, all of which are in communication with a semantic bus 120. The autonomic system 100 also includes several DEN-ng entities, i.e., a DEN-ng information model 145, DEN-ng derived data models 150, and DEN-ng ontology models 155, all of which are in communication with the information bus 115. The information bus 115 and the semantic bus 120 enable all of the above elements to communicate with each other through their connection 170. An autonomic processing engine 160 is in communication with the semantic bus 120, the information bus 115, and the semantic model converter 110. The vendor converters 105 receive vendor-specific data from managed resources 165 through sensors, which may be embedded (an inherent part of the managed resources 165) or external. Sensors (not illustrated) are utilized to gather the vendor-specific data. The vendor converters 105 also transmit vendor-specific commands to the managed resources 165 through effectors, which like their sensor counterparts, may be embedded or external. Effectors (not illustrated) are utilized to transmit vendor-specific commands to the managed resources. The vendor converters 105 transmit normalized sensor data, in Extensible Markup Language (“XML”) form, to the semantic model converter 110. Similarly, normalized sensor data, used by the autonomic system, is sent from the semantic model converter 110 to the vendor converters 105, which translate it back to a form that the managed resources 165 can understand.

Input data and commands are converted and normalized by first matching their structure to an object-oriented model (such as DEN-ng, as embodied in the DEN-ng derived data models 150), and then translated into XML form by the vendor converters 105. The XML data is then passed to the semantic processing engine 140, which augments the XML data with semantic information obtained from the rest of the system, but in particular from the Learning and Reasoning Repositories 135, Machine Learning Engine 130, Semantic Processing Engine 140, and/or DEN-ng Ontology models 155. This semantic information enables learning and reasoning processes to understand the relevance and significance of input data to the set of active working processes at hand. The current set of active contexts are used to enable a set of active policies that determine the specific set of learning and/or reasoning engines active at any given time.

As discussed herein, the autonomic system 100 may include sensors and effectors. The traditional definitions of sensors and effectors are as follows. A sensor is an entity such as a software program that detects and/or receives data and/or events from other system entities. An effector is an entity such as another software program that performs some action based on the received data and/or events. For example, in the case of a router malfunction, the sensors may receive data corresponding to the malfunction, and the effectors may implement corrective action to fix the malfunction.

With respect to the various embodiments disclosed herein, it should be appreciated that the above definitions are enhanced. Specifically, a sensor provides information, in the form of data and events, that can either be emitted from a managed resource 165 directly, passed on to that managed resource 165 from other managed resources (not shown in FIG. 1), or derived from one or more managed resources represented by 165. For example, it might be indicative of a general condition not generated by any one event, but experienced by one or more managed resources. Hence, the managed resource in this latter case simply becomes a convenient transport. Similarly, an effector provides commands that may be vendor-specific or vendor-independent to one or more specific managed resources.

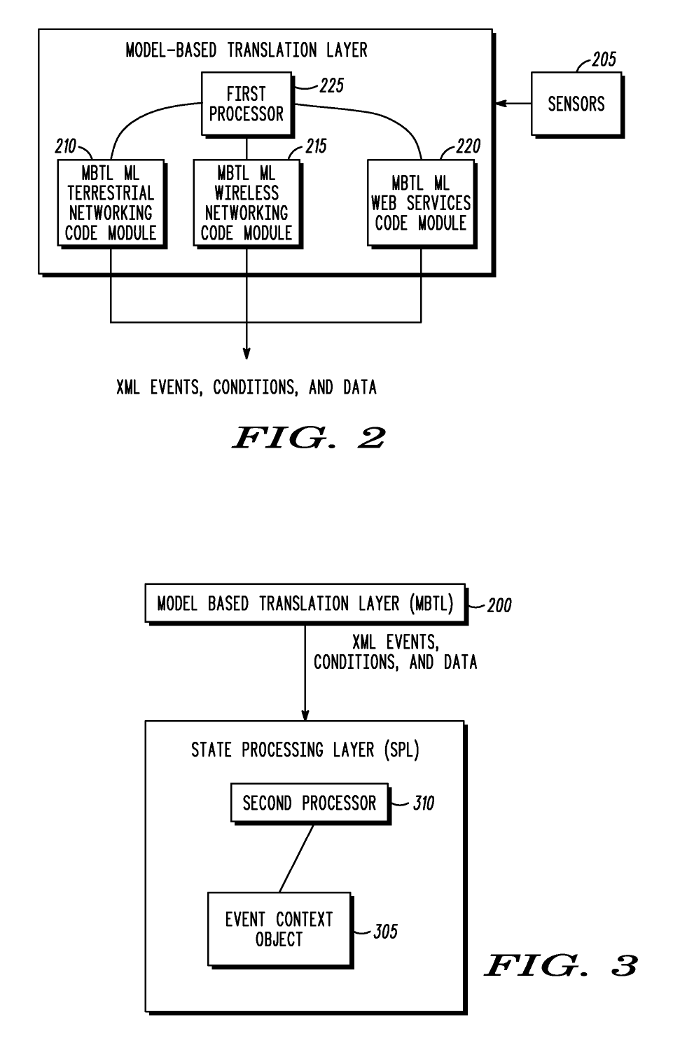

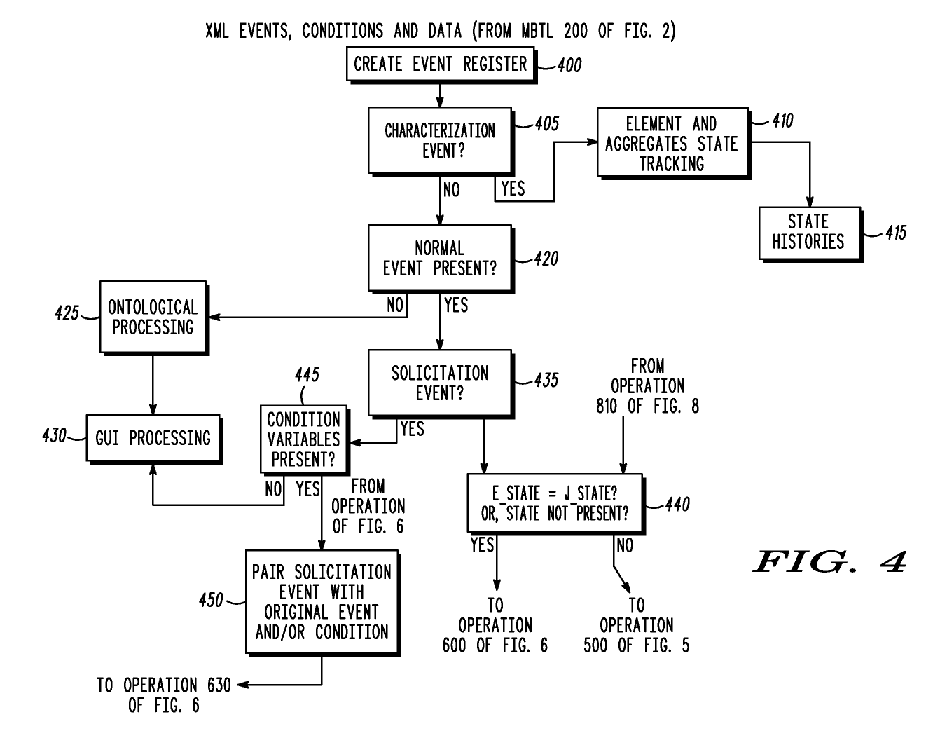

A machine learning system is described below with respect to FIGS. 2-10. The machine learning system is utilized to determine various information, such as element behavior, aggregate behavior, application behavior, application ensemble behavior (aggregated software functions), policy behavior, policy interaction behavior, dependencies, causal factors behind behaviors, predictive markers behind behaviors, and trends.

FIG. 2 illustrates a Model Based Translation Layer (“MBTL”) 200 according to at least one embodiment of the invention. The MBTL 200 provides for event qualification, state qualification, additional data qualification, and inferred event and state generation (if needed). The MBLT 200 is in communication with sensors 205 that detect and/or receive data and/or events from other system entities. The MBTL 200 includes an MBTL machine learning (“ML”) terrestrial networking code module 210, an MBTL ML wireless networking code module 215, and an MBTL ML web services code module 220. The MBTL terrestrial networking code module 210 stores code used to analyze data from networking elements. The MBTL ML wireless networking code module 215 stores code used to analyze data from wireless elements. The MBTL ML web services code module 220 stores code used to analyze data from other system events that communicate with the autonomics system 100 (from FIG. 1) using Web Services. A first processor 225 executes the code stored in the MBTL ML terrestrial networking code module 210, MBTL ML wireless networking code module 215, and MBTL ML web services code module 220, and outputs XML events, conditions, and data to a State Processing Layer (“SPL”) described below with respect to FIGS. 3-10.

The MBTL 200 provides statistical and rule-inference services. For example, it may provide further qualification to already supplied state information (for an element) by supplying interim results for items such as counters, averages, regressions, correlations, data-mining results, and event correlation engines. In addition, the inference tools in the MBTL 200 are also used to generate events at the aggregate of elements level and for individual elements of the system that are unable to generate events autonomously.

The MBTL's 200 statistical and rule-inference services may be enabled by parameters and policy control. The MBTL 200 may also be called upon in a “knowledge-directed data retrieval” capacity and its statistical and rule-inference services may be enabled by parameters and policy control.

The MBTL 200 examines events and information messages from the terrestrial networking, wireless access, and web services domains. The MBTL 200 generates three types of events. First, it generates characterization events. Characterization events are those synchronous and asynchronous events that are used in measurements of system attributes. In general, the measurement of system attributes is an holistic attempt to “describe” the functioning of the entire system, or various aspects of the system, and also provides a basis for comparison for the purposes of trending and inductive prediction.

The second type of events generated is solicitation events. Solicitation events are those events where the MBTL 200 responds to a request for additional or supplementary information from a State Processing Layer (“SPL) described below with respect to FIGS. 3-10. These are typically in response to the activities of machine learning processes in the State Processing Layer, and occasionally from abductive algorithms (e.g., homomorphic causal lattices).

The third type of events generated is normal events. Normal events are those events received by the MBTL 200 from elements, applications, and web services, or events generated as a consequence of policies, that direct the MBTL 200 to perform surveillance activities on primitive elements or aggregates of elements and infer events and state transitions. The MBTL 200 may also pass along conditional, contextual, or supplementary information from the element(s) under surveillance. The MBTL 200 harmonizes the inputs from the sensors 205, which may be in a number of different languages, and outputs events, conditions, and data in a single XML language.

FIG. 3 illustrates the MBLT 200 and the State Processing Layer (SPL) 300 according to an embodiment of the invention. The SPL 300 is utilized to accommodate several items, including: hierarchical state machines, nested state machines, signaling between the MBTL 200 and the SPL 300, scheduling and planning, dependencies, and concurrency.

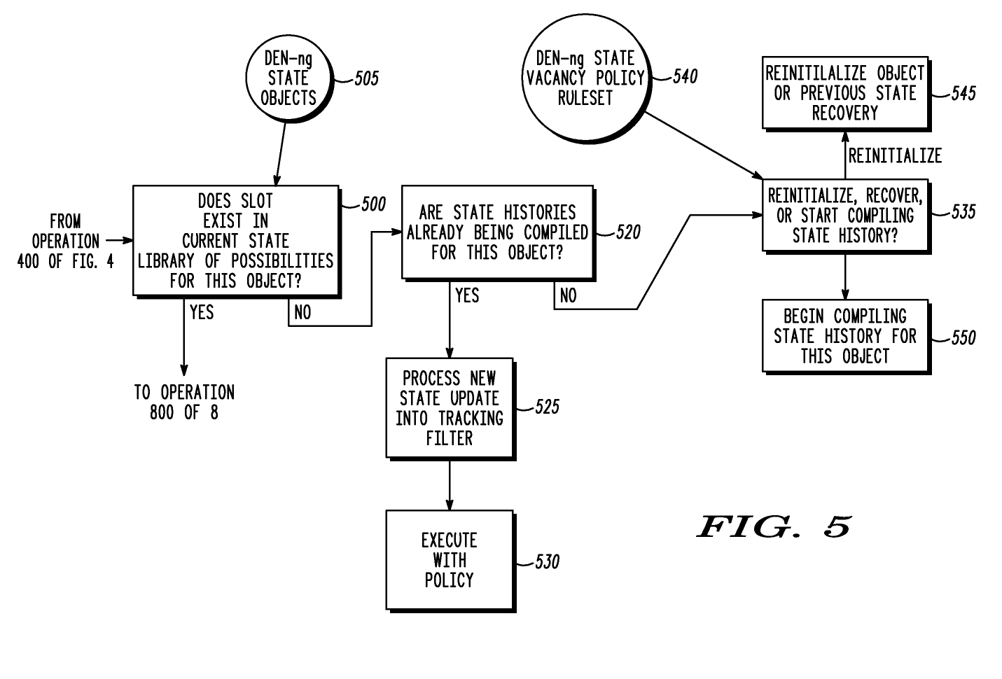

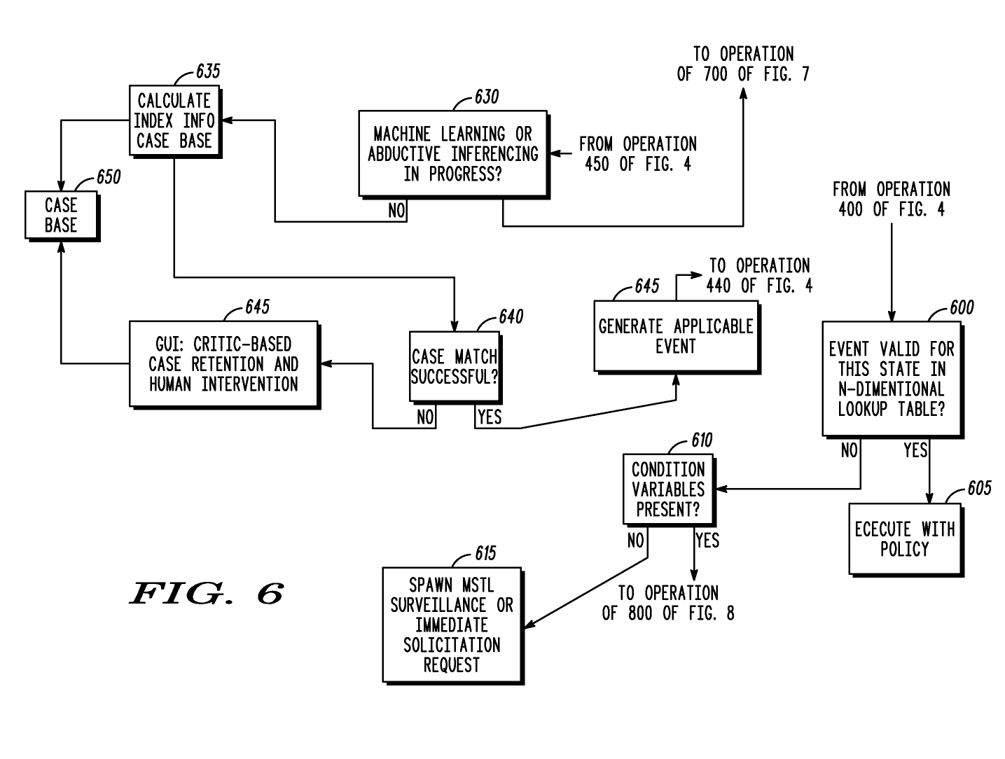

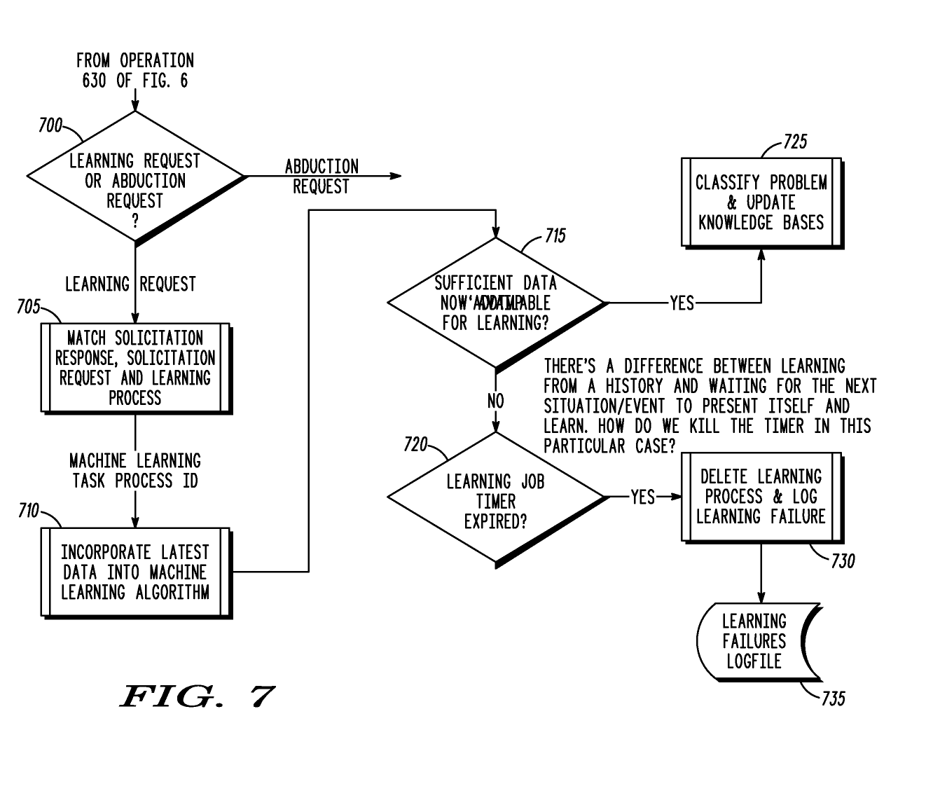

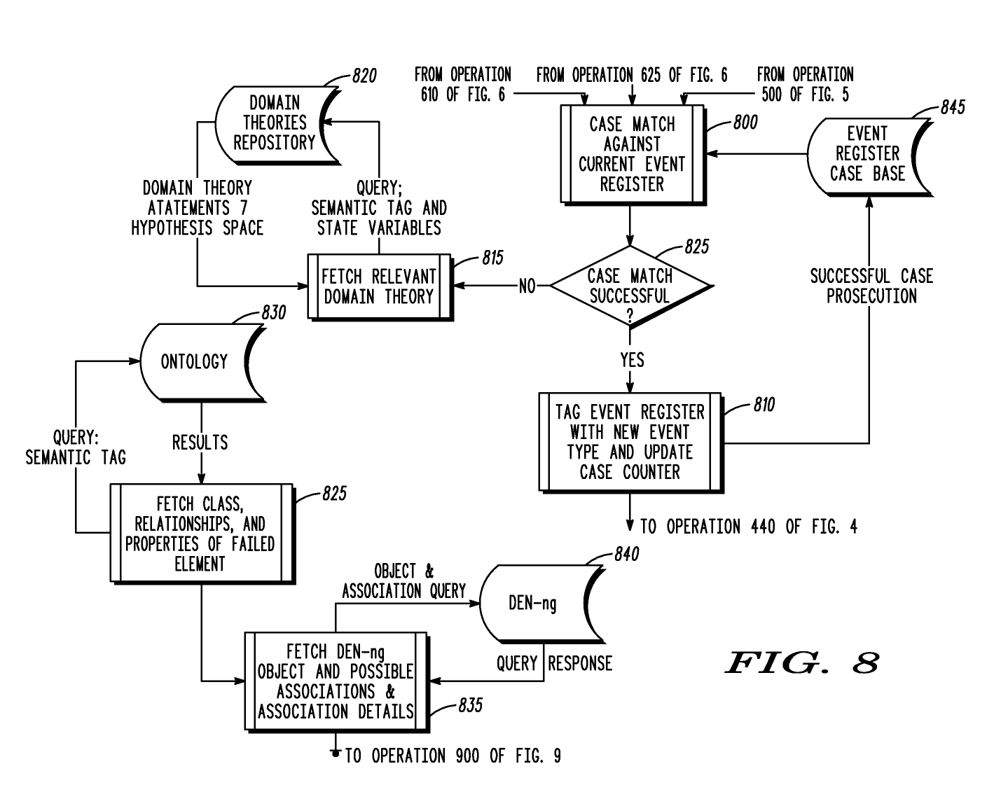

At the SPL 300, the XML message from the MBTL 200 is parsed by the second processor 310 and an “event context object” 305 is created. The event context object 305 contains the following information, most of which is drawn from local sources: (a) the DEN-ng object identity; (b) any semantic tagging affixed to the normalized XML message by the MBTL 200; and (c) the event from the MBTL 200. The event context object 305 may also include the state from the element or as inferred by the MBTL 200—this is referred to in FIGS. 4 and 5 discussed below as “E_State”, or the externally perceived state. The current process state of the element as understood by the autonomic manager may also be included in the event context object 305. This is referred to in the diagrams as “I_State”, or internally perceived state. This state is the expected state based upon the last effector action against the element.

The event context object 305 may also include the previous state of the element as understood by the autonomic manager. The event context object 305 may also include an N×2 array (where N is probably a small number) denoting nesting of state machines along with concurrency indicators. The autonomic manager control loop implementation may support features such as nesting of loops and concurrency of operation. States enveloping the current process state are designated as “superstates.”

FIG. 4 illustrates a first portion of a process flow of the SPL 300 according to at least one embodiment of the invention. In the SPL 300, screening is performed for characterization and solicitation events, falling through to comparison of the externally perceived state with the expected internal state. When this test is successful, a check is made for the validity of the state in an N-dimensional information matrix. This matrix has array attributes of event, perceived external state, internal state, previous internal state, previous perceived external state, and hierarchical superstate. If the event-state tuple is deemed valid, then policy control of lookup action functions is invoked to address the event. This is descriptive of nominal processing, and it should be understood that a great deal of activity on the part of the autonomic system follows (i.e., more parts to the control loop architecture) after this.

First, at operation 400, the XML events, conditions, and data are received from the MBTL of FIG. 2 and the event context object 305 is created. Next, a determination is made as to whether a characterization event is present at operation 405. If “yes,” processing proceeds to an elements and aggregates state tracking operation 410 and then to a state histories operation 415. The discoveries made at operations 410 and 415 inform abductive/inductive operations and automatic and adaptive selection of observation (phase space) variables and windowing based on theories of operation. Operations 410 and 415 function process analog representations of the entire machine learning system or parts of the system in order to provide input-to-inductive learning processes.

If a determination is made at operation 405 that a characterization event is not present, processing determines whether a normal event is present at operation 420. Operation 420 screens against known events. When this test fails, the system determines that the input is something that has never been seen before.

If “no” at operation 420, processing proceeds to an ontological processing operation 425. At the ontological processing operation 425, XML attributes are examined for their “type.” The current structure of a set of ontologies is searched for an exact match. If no exact match is located, then the processing searches for other ontological relationships, such as synonyms, antonyms, and meronyms. While there may be several approaches to determining similarity between concepts held in ontological structures, the various embodiments described herein are concerned with attributes, slots, and properties that have similar functions. These are called “synonyms”. If there are synonyms, the rest of the information structure in the set of ontologies is updated and processing proceeds to a Graphical User Interface (“GUI”) operation 430 where a message is indicated that an anomaly has occurred, i.e., that some error has occurred in the normal course of event-condition processing. If there are no synonyms, processing proceeds to a Graphical User Interface (“GUI”) operation 430 were a message is indicated that an anomaly has occurred (i.e., that some error has occurred).

If a determination is made at operation 420 that a normal event is present, processing proceeds to operation 435 where a determination is made as to whether a solicitation event is present. Solicitation events occur in response to situations where the system needs additional information to enable machine learning and/or reasoning.

If “no” at operation 435, processing proceeds to operation 440 where a determination is made as to whether the externally-perceived state, E_State, is the same as the internally-perceived state, I_State. The determination is made as to whether the state as perceived by the element (or inferred for an aggregate of elements) matches the expected internally-perceived state. This may also embody notions of nested states (hierarchy) or concurrency. If “yes” at operation 440, processing proceeds to operation 600 of FIG. 6. If “no” at operation 440, on the other hand, processing proceeds to operation 500 of FIG. 5.

Referring back to operation 435, if a determination is made that a solicitation event is present, processing proceeds to operation 445 where a determination is made as to whether condition variables are present. If “no,” processing proceeds to the GUI processing operation 430 to signal an anomaly. If “yes,” processing proceeds to operation 450 where the solicitation event is paired with the original event and/or condition, and then processing proceeds to operation 630 of FIG. 6.

The flow for handling solicitation events is discussed above. The “requests for additional information” are sent under a number of circumstances. When the request is sent, a process is spawned and the event context object contents and other information are sent to the process. This includes a process ID, also sent with the request that allows pairing the response with the process waiting for the results. A further check separates machine learning and abductive support requests from simple event “out of scope” conditions.

There are several techniques available to facilitate case matching. If a case match is successful, then the probable event associated with that case is used to replace the event in the original event context object 305. This is then passed on for normal processing to the internal-external state comparison operation 420.

In the instance where the case-matching step fails, the event context object 305 and the addendum data from the solicitation request are passed to a human-based critic function. The human (technician) may elect to ignore the phenomenon or to specify changes or additions to the criteria to one or more cases that could possibly service this event. At that point, the new or augmented old case could then be inserted into the case base for future use (again, at human discretion).

FIG. 5 illustrates a second portion of a process flow of the SPL 300 according to at least one embodiment of the invention. An input from operation 440 of FIG. 4 is received at operation 500, where a determination is made as to whether the E_State exists in the current state library of possibilities for this object. A DEN-ng state object module 505 may be utilized in making this determination. If “yes,” processing proceeds to operation 800 of FIG. 8, discussed below, where one or more intelligent learning and reasoning operations occur. At this point, it is desirable to reason about the current state of the element (or aggregate of elements) and how the system arrived at this state. Policy-directed rules will then dictate what actions are to be performed once the system has a reason and how this might fit into a nested or concurrent process.

If a determination of “no” occurs at operation 500, processing proceeds to operation 520 where a determination is made as to whether state histories are already being compiled for this object. If “yes,” processing proceeds to operation 525 where a new state update is processed into a tracking filter, and then at operation 530, an execution with policy occurs. The policy here dictates how long the system is permitted to pursue unmodeled state discovery and learning.

If a determination of “no” occurs at operation 520, processing proceeds to operation 535 where a determination is made whether to reinitialize, recover, or start compiling a state history. A DEN-ng state vacancy policy ruleset 540 may be utilized in making this determination. If a determination is made at operation 535 that the reinitialization should occur, processing proceeds to operation 545 where the object is reinitialized or the previous state is recovered. If, on the other hand, a determination is made at operation 535 to start compiling state history for the object, processing proceeds to operation 550 where this operation takes place.

FIG. 6 illustrates a third portion of a process flow of the SPL 300 according to at least one embodiment of the invention. At operation 600, a determination is made as to whether the event is valid for the state in an N-dimensional lookup table. A determination is made as to whether the state-event combination is covered by the precompiled or current working set of dynamic models.

If “yes” at operation 600, processing proceeds to operation 605 where an execution with policy occurs. If “no,” processing proceeds to operation 610 where a determination is made as to whether condition variables are present. If “no,” processing proceeds to operation 615 where either MBTL surveillance or an immediate solicitation request is spawned. If “yes” at operation 610, processing proceeds to operation 800 of FIG. 8, discussed below, where intelligent learning and reasoning is implemented and a policy ruleset is utilized.

Processing proceeds from operation 450 of FIG. 4 to operation 630 of FIG. 6. As shown, a determination is made as to whether machine learning or abductive inferencing for the current event context object 305 is in progress at operation 630. If “yes,” processing proceeds to a machine learning and inferencing tool at operation 635. If “no,” processing proceeds to operation 635 where the index is calculated into the case base. Since the solicitation event is already paired with the original event and/or condition, this operation may be a very targeted subset of the case-base. Processing subsequently proceeds to operation 640 where a determination is made as to whether the case match was successful. If “yes,” processing proceeds to operation 645 where the applicable event is generated and then processing proceeds to operation 440 of FIG. 4.

If, on the other hand, the case match is not successful at operation 640, processing proceeds to operation 645 where one or more GUI critic-based case retention and human intervention operations occur. Processing subsequently proceeds to operation 650 where a case base operation takes place and then processing proceeds to operation 635.

In the case where the perceived external state does not match the expected internal state, a further check is made regarding the external state validity according to the knowledge that the system has about possible element(s) behavior. This information may come from a DEN-ng model or other source. If the state is “out of scope,” then control will pass to a mechanism that, based on policy control, will make one of several decisions. It may decide if behavioral modeling is in order. This would allow the system to possibly learn unexpected or previously unmodeled behavior. There are many methods that may be employed in the process of behavioral modeling (e.g. Kalman Filtering or Hidden Markov Models).

Additionally, the policy may specify a recovery or restart operation. Examples of these last two items would be in cases of mission-critical operations where it is unacceptable for unknown states to persist only for the benefit of behavioral learning.

In the case where the perceived external state does not match the expected internal state and the state is “in scope,” then this represents a change to an element or aggregate of elements that was not anticipated by the state machine mechanism. In this instance, one may wish to learn more about why this happened and rectify the situation. This is accomplished through the processes of learning and reasoning, as discussed below.

If the SPL 300 recognizes the state but does not recognize the event type, or cannot associate the event with the current state machine(s), this would be another situation in which it is advantageous to learn more about why this happened and rectify the situation. Again, this is accomplished through the processes of learning and reasoning as discussed below.

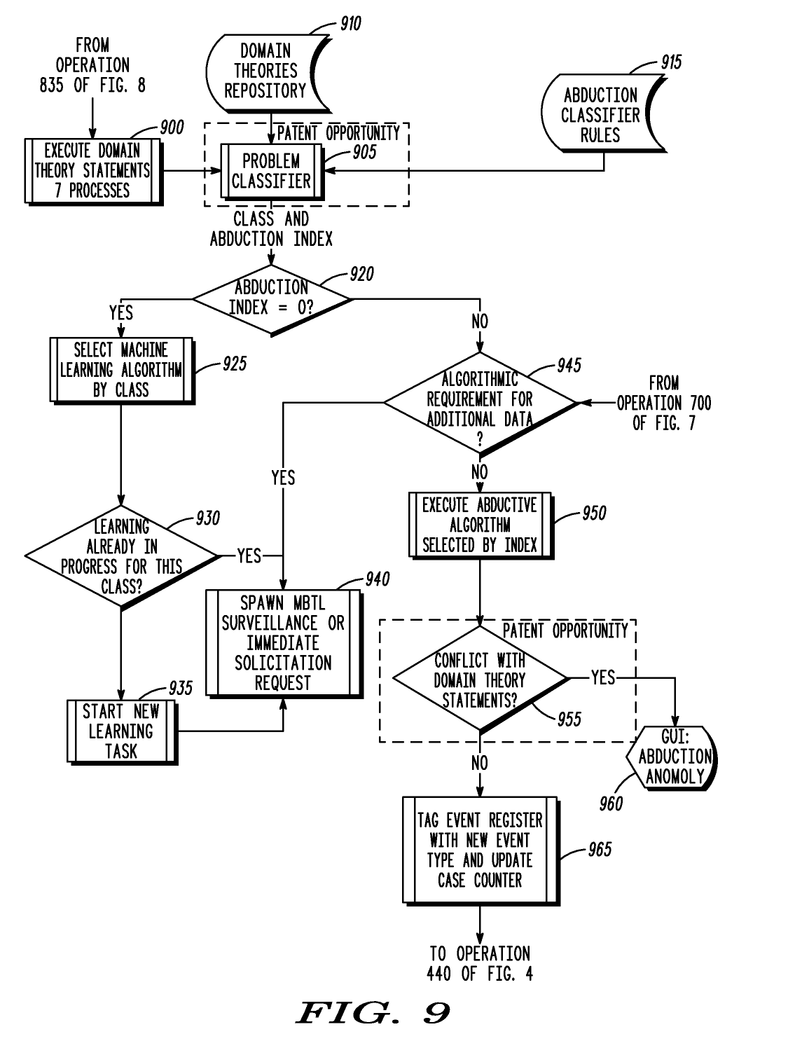

FIG. 7 illustrates solicitation response handling for machine learning according to at least one embodiment of the invention. FIG. 7 shows details regarding the incorporation of returned data for use in machine learning tasks. There are a variety of machine learning algorithms and the requirements for the various algorithms may not be identical. For example, concept learning requires multiple labeled and unlabeled examples to help narrow and refute membership in the “version space,” or the list of potential hypotheses regarding attributes of interest. In another example, decision tree learning may only require one query operation from a database facility that may unfortunately return a large volume of data. Thus, there is a check for sufficient relevant data available for the requirements of the machine learning task currently being processed.

First, at operation 700, an input is received from operation 630 of the third portion of the process flow of the SPL, and a determination is made whether a learning request or an abduction request is present. If an abduction request is present, processing proceeds to operation 945 of FIG. 9, as discussed below. If, however, a learning request is present, processing proceeds to operation 705 where the solicitation response, the solicitation request, and the learning process are matched and a machine learning task process identifier (“ID”) is output. Next, at operation 710, the latest data is incorporated into the machine learning algorithm. Processing proceeds to operation 715 where a determination is made whether sufficient data is now available for learning. If “yes,” processing proceeds to operation 725 where the problem is classified and knowledge bases are updated. If “no,” on the other hand, processing proceeds to operation 720 where a determination is made as to whether a learning job timer is expired. If the learning job timer is not expired, processing continues. If the learning job timer expires, however, processing proceeds to operation 730 where the learning process is deleted and a log learning failure error is indicated. Finally, processing proceeds to operation 735 where a learning failures logfile is generated/updated.

FIG. 8 illustrates an intelligent reasoning and learning configuration and process flow according to at least one embodiment of the invention. First, at operation 800, inputs are received from either operations 610 or 625 of FIG. 6 or from operation 500 of FIG. 5, and the inputs are case matched against the current event context object 305. At this point, the system knows both condition variables and a state which are present in the DEN-ng model.

Next, at operation 805, a determination is made as to whether the case match is successful. If “yes,” processing proceeds to operation 810 where the event context object 305 is tagged with a new event type and a case counter is updated. Processing then proceeds to operation 440 of FIG. 4 and in the event of a successful case prosecution, the event context object case base 845 is updated.

Referring back to operation 805, processing proceeds to operation 815 if a case match is not successful, and then the relevant domain theory is fetched from a domain theories repository 820. A query for semantic tag and state variables is sent to the domain theories repository 820, and domain theory statements for a hypothesis space is received. Next, processing proceeds to operation 825 where the class, relationships, and properties of a failed element are fetched from one or more ontologies 830. A query for one or more semantic tags is sent to the set of ontologies 830, and the results are received. Processing then proceeds to operation 835, where DEN-ng objects and possible associations (and association details) between objects are fetched from a DEN-ng database 840. A query for DEN-ng objects and associations is transmitted and a response is received back from the DEN-ng database 840. Processing subsequently proceeds to operation 900 of FIG. 9.

The learning and reasoning functions are separated into two distinct parts. The first part deals with implementation of case-based reasoning as a relatively efficient (in the computational sense) means towards problem resolution. Failing that, the control flow depicts acquisition of axiomatic and domain knowledge regarding the problem element. The second part deals with advanced problem resolution functions utilizing analytic learning and/or abductive reasoning.

FIG. 8 shows the processing flow where additional information or information from a solicitation is operated upon by a second case-based reasoning process. The difference between this case execution and that described above is that this case reasoner is focused on internal-external state mismatches and not on unexpected, unmodeled events. Case match success is treated in the same way above, where the case matched contains the probable event to substitute into the event context object and then forward control to the internal/external state check in FIG. 4 discussed above.

However, failing the case match, control is passed to blocks which retrieve more information about the problem from internal knowledge sources. The first source queried is that of the domain theories repository 820. The semantic tags (from the XML message from the MBTL 200), the current state, the previous state, and possible superstate information are used as query attributes to retrieve relevant information from the repository.

It should be understood that domain theories (such as statements and processes) may be encoded in many different ways. In general, domain theory may take the form of precompiled software statements (perhaps even at the subroutine or predicate levels) that provide logical consistency checking, diagnostic, or falsification functions, or it may take the form of measurement values or ranges. The domain theory may be used to steer the problem solving decision-making task (e.g. screen problem statement via event context object contents) as well as check the results of downstream machine learning operations and abductive conclusions.

The domain theories repository 820 may be split into two parts. The first part contains those domain theories that are fundamental in the sense that they are “axiomatic”. These theories typically do not change as a function of time or deployment venue (environment). The second part contains those domain theories that are the results of inductive operations, learned behaviors, or specifics of the deployment venue (environment). Examples of these include, but are not limited to, physical connectivity, logical connectivity, operating ranges, upper and lower bound representations, etc.

In the absence of domain theory, it is still possible that the results of the machine learning classification task, and subsequent execution of the selected machine learning algorithm(s), would yield useful information in future problem classification tasks by the autonomic manager. In one embodiment, the results of the machine-learning algorithm in this case could be forwarded to a GUI for human inspection. The semantic tags are then used to query one or more ontologies. The set of ontologies provides information on class attributes, relationships between classes, and possibly additional information not yet modeled in the information and data models.

Finally, the set of DEN-ng object IDs are used to query the DEN-ng repository 840 for associations, compositions, aggregations, and cardinality/ordinality details. In one preferred embodiment, the class results from the ontology query results can be used for at least two purposes. First, it can retrieve new information not represented in the DEN-ng repository. This is because the information source and structure is fundamentally different than that of the information model (note that for flexibility, the information may not be integrated into the DEN-ng repository until such time as it is needed). Second, it can retrieve additional information from the DEN-ng repository 840 other than that indicated by the set of DEN-ng object IDs. For example, if the ontology query results indicate a “synonym class relationship,” then that information can be used to search against DEN-ng object types to find other classes and/or attributes that are synonyms of the original DEN-ng object. This in effect merges the information in the information and data models with the information in the ontologies, uncovering hidden relationships that otherwise would not have been apparent. All of this information (domain theory, ontological information, and structural information from DEN-ng) is captured in a working memory and passed on to the learning and reasoning process of FIG. 9, discussed below.

FIG. 9 illustrates analytic/machine learning & abductive reasoning flow according to at least one embodiment of the invention. First, at operation 900, an input is received from operation 835 of FIG. 8, and domain theory statements and processes are executed. The output of this execution task here is a list of those domain theories found to be true and those found to be false. Some domain theories may require additional solicitation requests be sent to the MBTL 200. Besides the state mismatch or unknown event, the failed statements and processes of the domain theory may combine together to put additional precision on a “manifestations” attribute of the abductive-diagnostic problem.

Next, a problem classifier operation 905 occurs. The problem classifier may be as simple as a lookup table or as complicated as a case based reasoner or rule-based expert system. Alternatively, it may be even more complicated, where reasoning is applied to the objects, classes, and relationships supplied. At the problem classifier operation 905, inputs are received from a problem classifier policy ruleset 910 and abduction classifier rules 915.

Based upon the semantic tag, the list of successful domain theory, the list of unsuccessful domain theory, the ontology query results, and the DEN-ng query results, the problem classification task can take place. A problem classifier which performs the problem classifier operation 905 will take this information and will decide whether already existing abductive algorithms can be used to determine the cause of the event-state malfunction, or whether additional learning about the problem needs to take place. To do this, the problem classifier has access to the repository 915 of abductive devices (such as lattices, graphs, and algorithms) and their general properties.

In its most simplistic instantiation, the problem classifier is merely a lookup table indexed by semantics, ontological query results, and DEN-ng query results. The contents of the lookup table may be either a pointer to a specific abductive reasoning algorithm or one, or more, machine learning algorithms. However, the problem classifier may be significantly more complicated. Because of this, policy control of this important function is provided for in FIG. 9.

In a further embodiment of the problem classifier, a forward-chaining rule-based reasoning system is used to prioritize the possible responses. An example of the use of a rule-based classification system could be in situations where an association is explicit or implicit in either the ontology of DEN-ng query results. This indicates to the problem classifier that a machine-learning algorithm that provides concept learning would be useful in uncovering additional elements or processes involved in the problem or dysfunction. Another example would be an indication of deep structure from the DEN-ng composition or aggregation information. In this case, the problem classifier might elect to apply decision tree learning on both positively and negatively labeled examples to uncover split variables that potentially demarcate forcing functions for various behaviors.

At operation 920, a determination is made as to whether an abduction index is equal to zero. This operation 920 determines whether or not an abductive algorithm choice is sufficiently enabled from the information contained in the event context object, the domain theory, DEN-ng, and the ontology information. If “yes,” processing proceeds to operation 925 where the machine learning algorithm is selected by class. Next, a determination is made regarding whether learning is already in progress for this class at operation 930. If “no,” processing proceeds to operation 935 where a new learning task is started. Processing then proceeds to operation 940 where MBTL surveillance is spawned or an immediate solicitation request is generated. Referring back to operation 930, if the learning process was not already in progress, processing would also have advanced to operation 940.

Referring back to operation 920, if the abduction index is not equal to zero, a determination is made regarding whether there is an algorithmic requirement for additional data. If “yes,” processing proceeds to operation 940 where a solicitation request is spawned to the MBTL 200. If “no,” processing proceeds to operation 950 where the abductive algorithm selected by the index is executed.

Processing subsequently proceeds to operation 955 where a determination is made regarding whether there is a conflict with domain theory statements. That is, a check is made against the current domain theory is made to ensure that the result of the abductive algorithm does not violate any statements or processes previously found to be true. If “yes,” processing proceeds to a GUI-driven abduction anomaly process 960. If statements or processes are violated, this constitutes either an incorrect formulation of the abductive algorithm (such as an incorrect lattice segment) or an inappropriate application of the abductive algorithm to the current problem or dysfunction. In these instances, the abductive approach is terminated and all the information having to do with the problem/dysfunction, relevant domain theory, ontological query results, and DEN-ng query results are sent to a GUI. This information may be logged to a file to be subjected to further analysis by humans. Human intervention at this point involves either repair of the problem classifier algorithm(s) or, in the case of correct selection of abductive approach, repair of the abductive algorithm (such as posterior calculations or a causal lattice segment).

If “no,” at operation 955, processing proceeds to operation 965 where the event context object is tagged with a new event type and the case counter is updated. At this point only the event in the event context object 305 is being modified. Processing subsequently proceeds to operation 440 of FIG. 4.

On the machine-learning side of the execution flow, the algorithm selects from among a plurality of machine learning methods. A first check is made to determine if learning is already underway for this class of problem. This could be accomplished by inspection of all the current learning tasks in progress and their associated process IDs. In the case where no learning task was already in progress, a new process ID is generated and a process is spawned. A timeout value is associated with the process to ensure that “hanging processes” do not occur. Upon detection of a timeout, specifics about the machine-learning task are stored for later human evaluation.

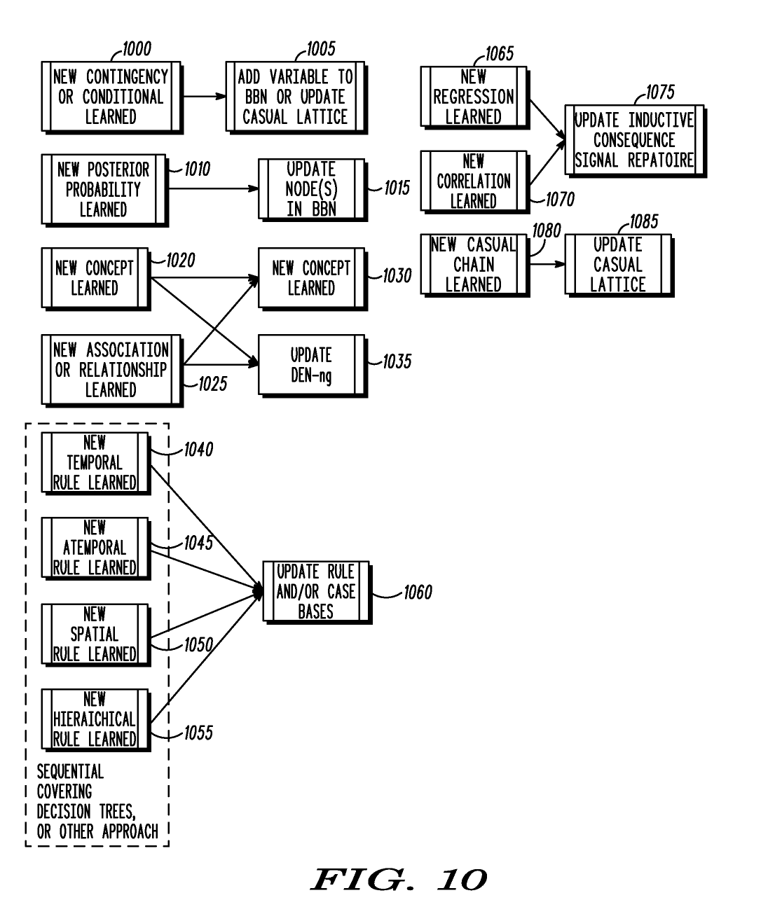

In the case where sufficient data is available for learning to proceed, the machine learning algorithm is invoked for all the data assembled (such as tree learning and cluster learning) or for the most recently retrieved data (such as concept learning, trending, and autocorrelation). The results of the machine-learning algorithm may then be subjected to checks against the domain theory relevant to the problem (as discussed above). Having passed the domain theory checks, the results may then be used to repair causal lattices, repair the domain theory, or abduce a new cause for a problem. However, some indication of the usefulness of machine learning output is provided for in FIG. 10.

FIG. 10 illustrates internal knowledge modification according to at least one embodiment of the invention. FIG. 10 illustrates system response to various causes. For example, if a new contingency or conditional is learned at operation 1000, a variable is added to a Bayesian Belief Network (BBN) or a causal lattice is updated at operation 1005. In response to a new posterior probability being learned at operation 1010, node(s) are updated in the BBN at operation 1015.

When either a new concept is learned at operation 1020 or a new association or relationship is learned at operation 1025, the set of ontologies is updated at operation 1030 and the DEN-ng database is updated at operation 1035. Also, if a new temporal rule is learned at operation 1040, a new atemporal rule is learned at operation 1045, a new spatial rule is learned at operation 1050, or a new hierarchical rule is learned at operation 1055, then the rule and/or case bases are updated at operation 1060. When a new regression is learned at operation 1065 or a new correlation is learned at operation 1070, an inductive consequence/sequel repertoire is updated at operation 1075. Finally, if a new causal chain is learned at operation 1080, a causal lattice is updated at operation 1085. In the case where no additional, automated processing on the output of the machine-learning results is desired, notification of technicians via a GUI is also an option.

The teachings described above presented a novel architecture for processing of event-state tuples with additional and supplementary information in an autonomic computing environment by combining the following software mechanisms in a new and novel way. For example, use of the event context object 305 captures information relevant to perceived external state, internal state, and indications for nesting and concurrency for hierarchical state machines. An N-dimensional lookup table is used as a first means to process event-state tuples. Case-based reasoning is used as a second means to process event-state tuples upon detection of internal-external state mismatch. The use of analytical learning is utilized as a first means for hypotheses preparation. Semantic tagging, current state, previous state, and possibly superstate are utilized to assist in the retrieval of relevant domain theory (from a domain theory repository) upon problem detection.

Domain theories are separated and delineated into axioms and current operating theories. A plurality of machine learning algorithms is used in support of analytic learning. Ontology and DEN-ng knowledge representation sources and types are utilized to assist in the classification of machine learning and abductive reasoning tasks. A knowledge-directed data retrieval process is utilized where the additional data requirement is at least a function of the machine learning or abductive algorithm selected for processing.

A mechanism is provided for handling exceptions when external element, or aggregate of elements, state does not match internal management engine state. Policy control of various aspects of the control flow execution are provided, including selection of machine learning and abduction algorithms, governance of behavioral induction, and the limits of case matching for a case-based reasoning algorithm.

Dynamic selection of machine learning and abductive reasoning algorithms is provided. This approach integrates relevant domain theory to the problem or dysfunction being processed, structural and associative knowledge from DEN-ng as well as classification, attribute, and relationship knowledge from one or more ontologies.

The teachings discussed herein are directed to a method. A message is received from a Model-Based Translation Layer. The message is parsed to determine an event, and at least one of an externally perceived state of the event and an internally perceived state of the event. A type of the event is determined, as well as whether the externally perceived state of the event is substantially equivalent to the internally perceived state of the event. The method includes invoking policy control to lookup action functions to address the event in response to determining that a combination of the type of the event and the externally perceived state of the event is determined to be valid.

The parsing may also include generating at least one of an event context object and a set of objects to store the event, the externally perceived state of the event, and the internally perceived state of the event. The type may be one of a characterization event used to measure system attributes, a solicitation event used to request additional information, and a normal event generated according to policies that direct the Model-Based Translation Layer to perform surveillance activities.

The method may also include updating a set of state histories to describe a system element in response to the type being a characterization event. Ontological processing may be performed for the event to determine a matching pre-determined event in an ontology in response to a determination that the type is not a normal event. The method may further include pairing, in response to the type being a solicitation event, the solicitation event with an original event utilized by the Model-Based Translation Layer to generate the message. At least one of machine learning and abductive reasoning may be performed on the solicitation event. Case-based reasoning may also be performed on the solicitation event.

The teachings discussed herein are also directed to a system. A Model-Based Translation Layer generates an output message having a common language and protocol by at least one of: inferring a new event from previous events received from external entities, and accepting at least one input event defined in any of a pre-determined set of languages and protocols. A State Processing Layer is utilized to (a) parse the output message to determine an event, an externally perceived state of the event, and an internally perceived state of the event; (b) determine a type of the event; (c) determine whether the externally perceived state of the event is substantially equivalent to the internally perceived state of the event; and (d) invoke policy control to lookup action functions to address the event in response to determining that a combination of the type of the event and the externally perceived state of the event is determined to be valid.

The system may also include at least one event context object to store the event, the externally perceived state of the event, and the internally perceived state of the event. A memory may store a set of state histories to describe a system element in response to the type being a characterization event. At least one ontology is utilized for performing ontological processing for the event to determine a matching pre-determined event in response to a determination that the type is not a normal event. A processor is included to, in response to the type being a solicitation event, pair a solicitation event with an original event utilized by the Model-Based translation Layer to generate the message.

These teachings are also directed to an apparatus. A State Processing Layer is utilized to: (a) parse a message received from a Model-Based Translation Layer to determine an event, an externally perceived state of the event, and an internally perceived state of the event; (b) determine a type of the event; (c) determine whether the externally perceived state of the event is substantially equivalent to the internally perceived state of the event; (d) store the event, the externally perceived state of the event, and the internally perceived state of the event in at least one event context object; and (e) invoke policy control to lookup action functions to address the event in response to determining that a combination of the type of the event and the externally perceived state of the event is determined to be valid.

The apparatus may include a memory to store a set of state histories to describe a system element in response to the type being a characterization event. At least one ontology may be utilized for performing ontological processing for the event to determine a matching pre-determined event in response to a determination that the type is not a normal event. A processor may be utilized to, in response to the type being a solicitation event, pair a solicitation event with an original event utilized by the Model-Based translation Layer to generate the message.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the current inventive concept.

We claim:

1. A method, comprising:
receiving a message from a Model-Based Translation Layer;
parsing the message to determine an event, and at least one of an externally perceived state of the event and an internally perceived state of the event;
determining a type of the event;
determining whether the externally perceived state of the event is substantially equivalent to the internally perceived state of the event; and
invoking policy control to lookup action functions to address the event in response to determining that a combination of the type of the event and the externally perceived state of the event is determined to be valid.

2. The method of claim 1, the parsing further comprising generating at least one of an event context object and a set of objects to store the event, the externally perceived state of the event, and the internally perceived state of the event.

3. The method of claim 1, the type being one of a characterization event used to measure system attributes, a solicitation event used to request additional information, and a normal event generated according to policies that direct the Model-Based Translation Layer to perform surveillance activities.

4. The method of claim 3, further comprising updating a set of state histories to describe a system element in response to the type being a characterization event.

5. The method of claim 3, further comprising performing ontological processing for the event to determine a matching pre-determined event in an ontology in response to a determination that the type is not a normal event.

6. The method of claim 3, further comprising pairing, in response to the type being a solicitation event, the solicitation event with an original event utilized by the Model-Based Translation Layer to generate the message.

7. The method of claim 6, further comprising performing at least one of machine learning and abductive reasoning on the solicitation event.

8. The method of claim 6, further comprising performing case-based reasoning on the solicitation event.

9. A system, comprising:
a Model-Based Translation Layer to generate an output message having a common language and protocol by at least one of: inferring a new event from previous events received from external entities, and accepting at least one input event defined in any of a pre-determined set of languages and protocols;
a State Processing Layer to:
parse the output message to determine an event, an externally perceived state of the event, and an internally perceived state of the event;
determine a type of the event;
determine whether the externally perceived state of the event is substantially equivalent to the internally perceived state of the event; and
invoke policy control to lookup action functions to address the event in response to determining that a combination of the type of the event and the externally perceived state of the event is determined to be valid.

10. The system of claim 9, further comprising at least one event context object to store the event, the externally perceived state of the event, and the internally perceived state of the event.

11. The system of claim 9, further comprising a memory to store a set of state histories to describe a system element in response to the type being a characterization event.

12. The system of claim 9, further comprising at least one ontology utilized for performing ontological processing for the event to determine a matching pre-determined event in response to a determination that the type is not a normal event.

13. The system of claim 9, further comprising a processor to, in response to the type being a solicitation event, pair a solicitation event with an original event utilized by the Model-Based translation Layer to generate the message.

14. An apparatus, comprising:
a State Processing Layer to:
parse a message received from a Model-Based Translation Layer to determine an event, an externally perceived state of the event, and an internally perceived state of the event;
determine a type of the event;
determine whether the externally perceived state of the event is substantially equivalent to the internally perceived state of the event;
store the event, the externally perceived state of the event, and the internally perceived state of the event in at least one event context object; and
invoke policy control to lookup action functions to address the event in response to determining that a combination of the type of the event and the externally perceived state of the event is determined to be valid.

15. The apparatus of claim 14, further comprising a memory to store a set of state histories to describe a system element in response to the type being a characterization event.

16. The apparatus of claim 14, further comprising at least one ontology utilized for performing ontological processing for the event to determine a matching pre-determined event in response to a determination that the type is not a normal event.

17. The apparatus of claim 14, further comprising a processor to, in response to the type being a solicitation event, pair a solicitation event with an original event utilized by the Model-Based translation Layer to generate the message.
